(19) United States
(12) Patent Application Publication
(10) Pub. No.: US 2025/0301121 A1
(43) Pub. Date: Sep. 25, 2025

(54) METHOD FOR INTER-PREDICTION OF CHROMA COMPONENT USING BI-PREDICTION

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jung Kyung Lee, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 18/860,533

(22) PCT Filed: Apr. 17, 2023
(86) PCT No.: PCT/KR2023/005155

§ 371 Date: Oct. 25, 2024

(30) Foreign Application Priority Data
May 12, 2022 (KR) 10-2022-0058181
Apr. 12, 2023 (KR) 10-2023-0048426

(51) Int. Cl. H04N 19/105; H04N 19/159; H04N 19/176

(52) U.S. Cl. CPC H04N 19/105; H04N 19/159; H04N 19/176

(57) ABSTRACT

A method is disclosed for inter-predicting chroma components by using bi-prediction. A video decoding device generates, for the current chroma block, a chroma bi-prediction block. The video decoding device derives weights of the current chroma block by using a first luma prediction block, a second luma prediction block, and a final luma reconstruction block of a luma block corresponding to the current chroma block. The video decoding device generates a final chroma prediction block of the current chroma block by applying the weights to the chroma bi-prediction blocks.

### TECHNICAL FIELD

The present disclosure relates to a method of inter-predicting chroma components by using bi-prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In the VVC technique, the advanced motion vector prediction (AMVP) mode of inter-prediction, when bi-prediction is performed, assigns weights at the coding unit (CU) level for two predicted signals derived by two motion vectors. This method is called Bi-prediction with CU-level Weight (BCW). In BCW, the decoder averages the two predicted signals based on the weight to generate the final predicted signals. Therefore, an efficient setting of these weights needs to be considered especially for the chroma component to increase video coding efficiency and enhance video quality.

### DISCLOSURE

### Technical Problem

The present disclosure seeks to provide a video coding method and an apparatus, in inter-predicting chroma components, that calculate weights at a decoder side using previously reconstructed luma prediction blocks or template matching. The video coding method and the apparatus apply the calculated weights to chroma bi-prediction blocks to generate a final prediction block.

### Technical Solution

At least one aspect of the present disclosure provides a method performed by a video decoding device for predicting a current chroma block. The method includes generating, for the current chroma block, chroma bi-prediction blocks that include a first chroma prediction block and a second chroma prediction block. The method also includes deriving weights of the current chroma block by using a first luma prediction block, a second luma prediction block, and a final luma reconstruction block of a luma block corresponding to the current chroma block. Here, the weights include a first chroma weight and a second chroma weight. The method also includes generating a final chroma prediction block of the current chroma block by applying the weights to the chroma bi-prediction blocks.

Another aspect of the present disclosure provides a method performed by a video encoding device for predicting a current chroma block. The method includes generating, for the current chroma block, chroma bi-prediction blocks that include a first chroma prediction block and a second chroma prediction block. The method also includes deriving weights of the current chroma block by using a first luma prediction block, a second luma prediction block, and a final luma reconstruction block of a luma block corresponding to the current chroma block. Here, the weights including a first chroma weight and a second chroma weight. The method also includes generating a first final chroma prediction block of the current chroma block by applying the weights to the chroma bi-prediction blocks.

Yet another aspect of the present disclosure provides a computer-readable recording medium storing a bitstream generated by a video encoding method. The video encoding method includes generating, for a current chroma block, chroma bi-prediction blocks that include a first chroma prediction block and a second chroma prediction block. The video encoding method also includes deriving weights of the current chroma block by using a first luma prediction block, a second luma prediction block, and a final luma reconstruction block of a luma block corresponding to the current chroma block. Here, the weights including a first chroma weight and a second chroma weight. The video encoding method also includes generating a final chroma prediction block of the current chroma block by applying the weights to the chroma bi-prediction blocks.

### Advantageous Effects

As described above, the present disclosure provides a video coding method and an that, in inter-predicting chroma components, calculate weights at the decoder side by using previously reconstructed luma prediction blocks or template matching. The video coding method and the apparatus apply the calculated weights to chroma bi-prediction blocks to generate a final prediction block. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a weighted chroma prediction.

FIG. 7 is a diagram illustrating the use of luma blocks in predicting chroma blocks, according to at least one embodiment of the present disclosure.

FIG. 8 is a diagram illustrating the calculation of differences between luma blocks and neighboring luma samples, according to at least one embodiment of the present disclosure.

FIG. 9 is a diagram illustrating template matching, according to at least one embodiment of the present disclosure.

FIG. 10 is a flowchart of a method of predicting a current chroma block performed by a video encoding device, according to at least one embodiment of the present disclosure.

FIG. 11 is a flowchart of a method of predicting a current chroma block performed by a video decoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

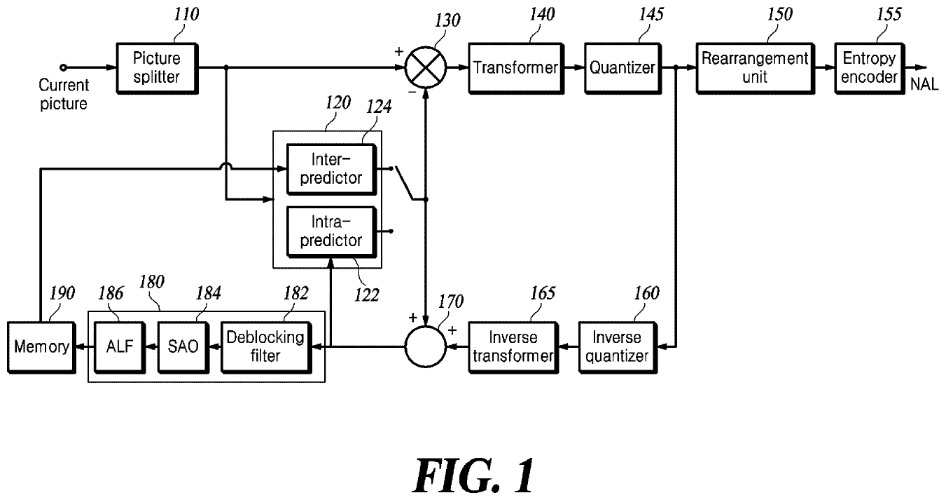

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

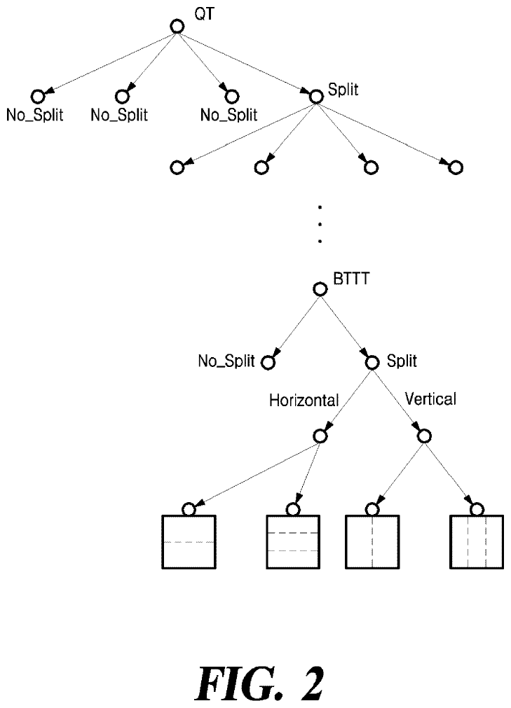

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

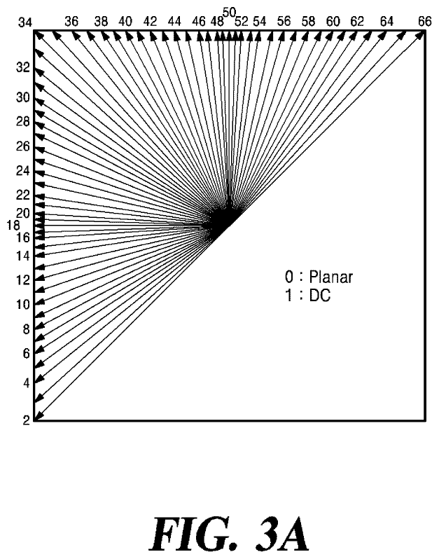

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

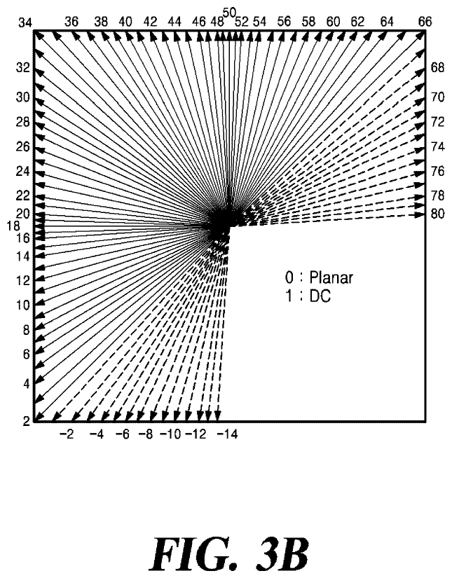

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

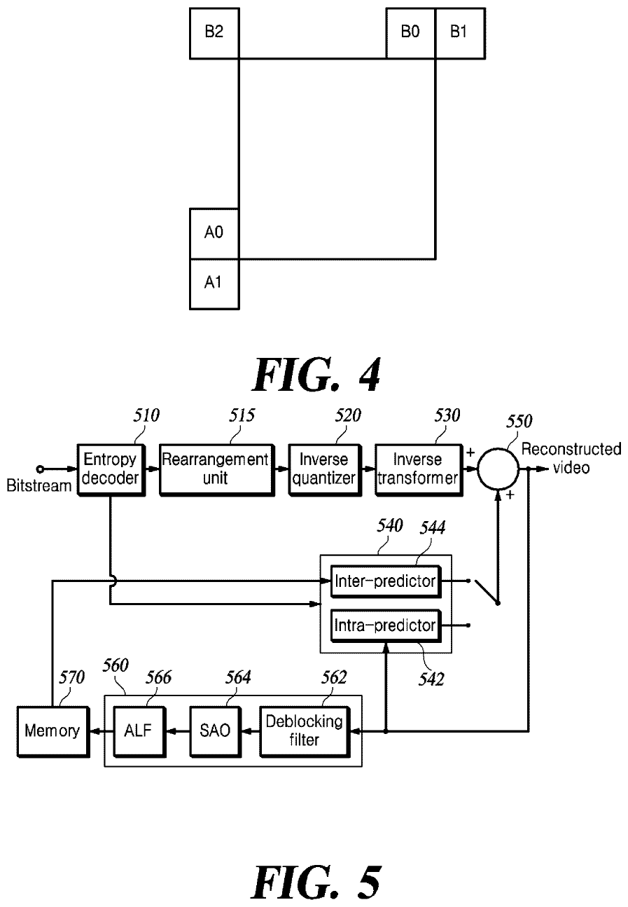

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, in inter-predicting chroma components, calculate weights at the decoder side by using previously reconstructed luma prediction blocks or template matching. The video coding method and the apparatus apply the calculated weights to chroma bi-prediction blocks to generate a final prediction block.

The following embodiments may be performed by the inter predictor 124 in the video encoding device. The following embodiments may also be performed by the inter predictor 544 in the video decoding device.

The video encoding device in the inter-predicting chroma components may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the inter-predicting of chroma components.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

Hereinafter, embodiments of the present disclosure are described centered about the video decoding device, but embodiments may be similarly applied to the video encoding device.

### I. Intra-Prediction Techniques

The following describes intra-prediction techniques for reference by the embodiments. Several techniques are introduced to improve coding efficiency by using intra prediction.

In the VVC (Versatile Video Coding) technique, the intra prediction mode of the luma block has 65 subdivided directional modes (i.e., 2 to 66) in addition to the non-directional modes (i.e., planar and DC), as illustrated in FIG. 3A. The 65 directional modes, planar and DC modes, are collectively referred to as 67 IPMs.

In the VVC technique, Cross-Component Linear Model prediction (CCLM) and Multi-Model Linear Model prediction (MMLM) are techniques for predicting chroma samples by determining correlations between luma and chroma components.

When the CCLM mode is applied for intra prediction of the current chroma block, the video decoding device determines a region in the luma image corresponding to the current chroma block (hereinafter, the ‘corresponding luma region’). The corresponding luma region's left reference pixel and top reference pixel and the target chroma block's left reference pixel and top reference pixel may be utilized for the prediction of the linear model. Hereinafter, the left reference pixels and the top reference pixels are commonly referred to as reference pixels, neighboring pixels, or adjacent pixels. Additionally, reference pixels in the chroma channel are denoted as chroma reference pixels, and reference pixels in the luma channel are denoted as luma reference pixels.

In CCLM prediction, to generate a prediction block, which is a predictor of the target chroma block, a linear model is derived between the reference pixels of the corresponding luma region and the reference pixels of the chroma block, and the linear model is applied to the reconstructed pixels of the corresponding luma region. For example, four pairs of pixels from combining pixels in the neighboring pixel line of the current chroma block with pixels in the corresponding luma region may be used to derive the linear model. The video decoding device may derive the linear model represented by α, β as shown in Equation 1 for the four pairs of pixels.

$$α = \frac{{Y}_{b} - {Y}_{a}}{{X}_{b} - {X}_{a}} , β = {Y}_{a} - α \cdot {X}_{a} \qquad [ Equation 1 ]$$

Here, for the corresponding luma pixels of the four pairs of pixels, Xₐ and X_{b} each represent the average of the two minimum values and the average of the two maximum values. Additionally, for the chroma pixels, Yₐ and Y_{b} each represent the average of the two minimum values and the average of the two maximum values. Then, the video decoding device may generate a predictor Pred_{C}[x][y] of the current chroma block from the pixel values rec′_{L}[x][y] of the corresponding luma region by using the linear model, as shown in Equation 2.

$${Pred}_{C} [ x ] [ y ] = a \cdot {rec}_{L}^{′} [ x ] [ y ] + β \qquad [ Equation 2 ]$$

As described above, the CCLM mode is divided into three modes, CCLM_LT, CCLM_L, and CCLM_T, depending on the location of the neighboring pixels used in the linear model derivation process. CCLM_LT mode uses two pixels in each direction among the adjacent pixels to the left and top of the current chroma block. CCLM_L mode uses four pixels among the adjacent pixels to the left of the current chroma block. Finally, CCLM_T mode utilizes four pixels among the adjacent pixels to the top of the current chroma block.

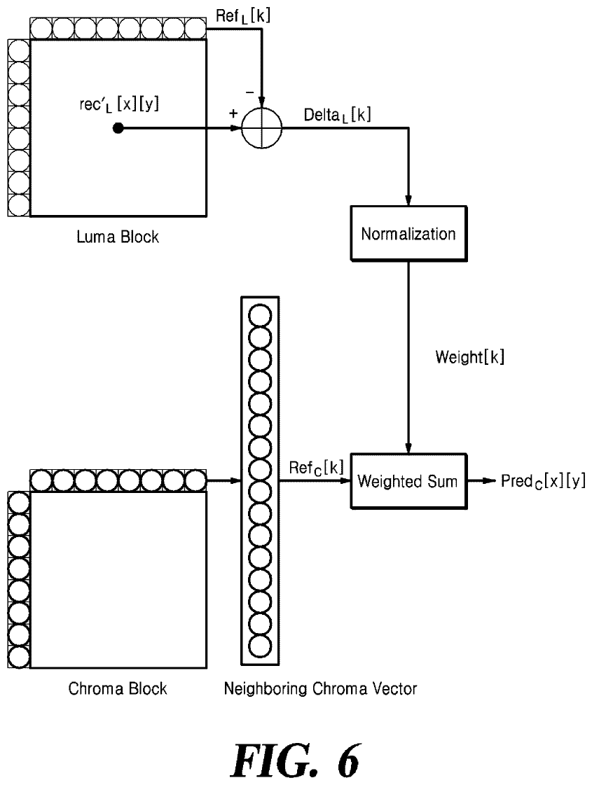

In the VVC technique, the weighted chroma prediction (WCP) uses the difference vector between the luma sample and the neighboring luma samples to calculate weights for the weighted summation of the neighboring chroma samples. Then, by weighted summing the neighboring chroma samples by using the calculated weights, a predictor of the chroma samples is generated, as illustrated in FIG. 6.

First, W is defined as the width of the chroma block and H is defined as the height of the chroma block. If necessary depending on the chroma format, the reconstructed luma block and neighboring luma samples may be downsampled. For x=0, . . . , W−1, y=0, . . . , H−1, the video decoding device calculates Delta_{L}[k], which is the absolute value of the difference between the luma samples rec′_{L}[x][y] in the reconstructed luma block and the neighboring luma vector Ref_{L}[k] of length K, as shown in Equation 3.

$${Delta}_{L} [ k ] = \vert {rec}_{L}^{′} [ x ] [ y ] - {Ref}_{L} [ k ] \vert \qquad [ Equation 3 ]$$

Here, k is an index indicating an element of the neighboring luma vector.

The video decoding device then calculates a weight vector Weight[k] by using a normalization process as shown in Equation 4.

$$Weight [ k ] = \frac{{Delta}_{L} [ k ]}{{\sum }_{n = 0}^{K - 1} {Delta}_{L} [ n ]} \qquad [ Equation 4 ]$$

By using the neighboring sample vector Ref_{C}[k] of the chroma block and the weight vector Weight[k], the video decoding device may calculate a predictor Pred_{C}[x][y] of the chroma samples for x=0, . . . , W−1, y=0, . . . , H−1, as shown in Equation 5.

$${Pred}_{C} [ x ] [ y ] = {\sum }_{k = 0}^{K - 1} Weight [ x ] [ y ] [ k ] \times {Ref}_{C} [ k ] \qquad [ Equation 5 ]$$

### II. Bi-Prediction with CU-Level Weight (BCW)

In the VVC technique, the advanced motion vector prediction (AMVP) mode of inter-prediction, when bi-prediction is performed, assigns weights for two predicted signals derived by two motion vectors, at the coding unit (CU) level. This method is called Bi-prediction with CU-level Weight (BCW). In BCW, the video decoding device generates the final predicted signals by averaging the two predicted signals based on the weights as in Equation 6.

$${P}_{bi - pred} = ( ( 8 - w ) \times {P}_{0} + w \times {P}_{1} + 4 ) >> 3 \qquad [ Equation 6 ]$$

Here, P₀ and P₁ denote the two bi-prediction signals.

In low-delay encoding, the weight w may be one of five weights {−2, 3, 4, 5, 10}. On the other hand, if the encoding is not a low-delay, the weight w may be one of three weights {3, 4, 5}. These CU-level weights may be determined by a weight index transmitted per CU in AMVP mode. In merge mode, the CU-level weights may be determined based on a merge candidate index.

As described above, in a conventional bidirectional inter prediction, preset weights are used for the luma component and the chroma component. The following describes a method of calculating the weight of the chroma component at the decoder side by utilizing the previously reconstructed luma component in addition to the chroma component when a bi-prediction on the chroma component is performed.

### III. Implementations According to the Present Disclosure

Similar to the luma signal, the bi-prediction of the chroma signals may also be provided with weights at the CU level. As shown in Equation 7, a BCW may be implemented to generate a final predicted signals by weighted summation of two predicted signals derived by two motion vectors.

$${P}_{bi - pred} = w 0 \times {P}_{0} + w 1 \times {P}_{1} \qquad [ Equation 7 ]$$

Hereinafter, w0 and w1 are referred to as the first chroma weight and the second chroma weight.

In this embodiment, instead of using preset weights as described above for the chroma components, the video decoding device adaptively calculates the weights of the chroma components. In this case, similar to a conventional BCW that uses preset weights, the adaptive weight derivation method may be controlled based on an on/off flag at the CU level (hereinafter referred to as a ‘chroma weight derivation flag’). For example, if the chroma weight derivation flag is true, the video decoding device derives the weights of the chroma prediction blocks according to implementations of the present disclosure. On the other hand, if the chroma weight derivation flag is false, the video decoding device derives the weights of the chroma prediction blocks according to a conventional method. Here, the conventional method may utilize preset weights as described above.

### <Implementation 1> Chroma BCW Using Weighted Chroma Prediction

In this implementation, the video decoding device performs Bi-prediction with CU-level Weight (BCW) for chroma components by using Weighted Chroma Prediction (WCP). Here, WCP uses the difference vector between the luma sample and the neighboring luma samples to calculate the weights. The calculated weights are then used for weighted prediction of the relevant chroma samples.

In this implementation, to perform BCW of the chroma components, the WCP may be applied as in Implementation 1-1 or Implementation 1-2.

### <Implementation 1-1> Using the Difference Between the Luma Bi-Prediction Blocks and the Final Luma Reconstruction Block

When BCW is performed on the luma component, bi-prediction blocks, pred0_{L} and pred1_{L}, and a final luma reconstruction block, pred_{L}^{rec}, are generated. Here, pred0_{L} and pred1_{L} denote the forward prediction block and backward prediction block of the luma block, respectively. Additionally, pred_{L}^{rec} equals the output of the adder 550. The video decoding device may utilize pred0_{L}, pred1_{L}, and pred_{L}^{rec} to determine the weights of the two predicted signals in the bi-prediction of the chroma component.

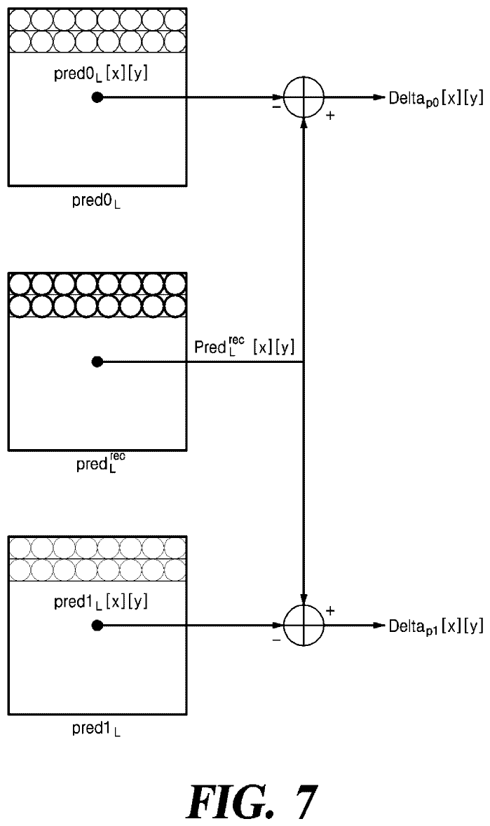

FIG. 7 is a diagram illustrating the use of luma blocks in predicting chroma blocks, according to at least one embodiment of the present disclosure.

The video decoding device calculates Deltaₚ₀ and Deltaₚ₁, which are absolute values of the difference between the luma bi-prediction blocks and the final luma reconstruction block, as shown in Equation 8.

$${Delta}_{p 0} [ x ] [ y ] = \vert pred {0}_{L} [ x ] [ y ] - {pred}_{L}^{rec} [ x ] [ y ] \vert \qquad [ Equation 8 ]$$

$${Delta}_{p 1} [ x ] [ y ] = \vert pred {1}_{L} [ x ] [ y ] - {pred}_{L}^{rec} [ x ] [ y ] \vert$$

In one example, if the chroma block has a size of W×H and the corresponding luma block has a size larger than the chroma block, the video decoding device may downsample Deltaₚ₀ and Deltaₚ₁ to the size of W×H. Alternatively, the luma block may first be downsampled to the size of W×H, and then the process of Equation 8 may be applied. Here, W represents the width of the chroma block and H represents the height of the chroma block. Hereinafter, Deltaₚ₀ and Deltaₚ₁ are referred to as the first difference block and the second difference block, respectively.

The final chroma prediction block Pred_{C} may be generated by using the bi-prediction blocks pred0_{C} and pred1_{C} of the chroma components. Here, pred0_{C} and pred1_{C} represent the forward prediction block and backward prediction block of the chroma block, respectively. At this time, the weights w0 and w1 of Equation 7 may be calculated for the chroma components by using Deltaₚ₀ and Deltaₚ₁. In this case, w0 and w1 may be determined differently for each chroma sample Pred_{C}[x][y].

First, the video decoding device calculates sum[x][y] as shown in Equation 9.

$$sum [ x ] [ y ] = {Delta}_{p 0} [ x ] [ y ] + {Delta}_{p 1} [ x ] [ y ] \qquad [ Equation 9 ]$$

Then, normalized w0[x][y] and w1 [x][y] are generated by dividing Deltaₚ₀ [x][y] and Deltaₚ₁ [x][y] by sum [x][y] such that the sum of w0[x][y] and w1 [x][y] is 1. Hereinafter, w0[x][y] and w1[x][y] are referred to as the first weighted block and the second weighted block. The video decoding device, respectively, performs a bi-prediction of the chroma components as shown in Equation 10 by using the weights normalized for x=0, . . . , W−1, y=0, . . . , H−1.

$${Pred}_{c} [ x ] [ y ] = w 0 [ x ] [ y ] \times pred {0}_{C} [ x ] [ y ] + w 1 [ x ] [ y ] \times pred {1}_{C} [ x ] [ y ] \qquad [ Equation 10 ]$$

Here, Pred_{C}[x][y] denotes the final predicted sample of the chroma component.

In one example, in Equation 10, a weight per chroma sample based on the luma blocks is utilized. As another example, the final predicted samples of the chroma component may be generated by using one weight per prediction block. For example, the video decoding device calculates the average μₚ₀ of Deltaₚ₀ and the average μₚ₁ of Deltaₚ₁ and then calculates w0=μₚ₀/(μₚ₀+μₚ₁), w1=μₚ₁/(μₚ₀+μₚ₁). Hereinafter, μₚ₀ and μₚ₁ are referred to as the first mean and the second mean, respectively. The video decoding device performs a bi-prediction of the chroma component as shown in Equation 11 by using the normalized weights for x=0, . . . , W−1, y=0, . . . , H−1.

$${Pred}_{c} [ x ] [ y ] = w 0 \times pred {0}_{C} [ x ] [ y ] + w 1 \times pred {1}_{C} [ x ] [ y ] \qquad [ Equation 11 ]$$

### <Implementation 1-2> Utilizing Differences Between Luma Blocks and Neighboring Luma Samples

As described above, when BCW is performed on the luma components, the bi-prediction blocks pred0_{L} and pred1_{L}, and the final luma reconstruction block pred_{L}^{rec} are generated. The pixel vectors around each block are defined as Ref₀, Ref₁, and Ref_{L}. The video decoding device calculates Deltaₚ₀, Deltaₚ₁, and Delta_{L}, which are the difference vectors between each luma block and the neighboring pixels, as shown in Equation 12. Hereinafter, Deltaₚ₀, Deltaₚ₁, and Delta_{L} are referred to as the first difference vector, the second difference vector, and the luma difference vector, respectively.

$${Delta}_{p 0} [ k ] = \vert pred {0}_{L} [ x ] [ y ] - {Ref}_{0} [ k ] \vert \qquad [ Equation 12 ]$$

$${Delta}_{L} [ k ] = \vert {pred}_{L}^{rec} [ x ] [ y ] - {Ref}_{L} [ k ] \vert$$

$${Delta}_{p 1} [ k ] = \vert pred {1}_{L} [ x ] [ y ] - {Ref}_{1} [ k ] \vert$$

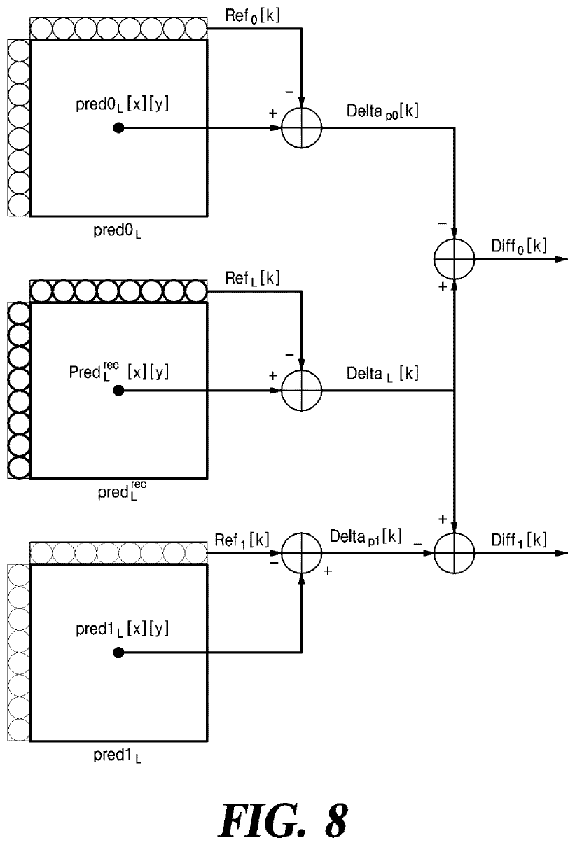

The video decoding device then calculates the weights for the chroma components by using Deltaₚ₀, Deltaₚ₁, and Delta_{L}. First, defined are that Diff₀=Delta_{L}−Deltaₚ₀ and Diff₁=Delta_{L}−Deltaₚ₁. Hereafter, Diff₀ and Diff₁ are referred to as the first bi-difference vector and the second bi-difference vector. If the number of pixels around the prediction block is K, then Diff₀ and Diff₁ are vectors of size 1×K, respectively. The example in FIG. 8 schematically illustrates how Diff₀ and Diff₁ are computed from the differences between luma blocks and neighboring luma samples.

For example, the video decoding device may use Diff₀ and Diff₁ to calculate the weights for the chroma components as follows. The video decoding device concatenates Diff₀ and Diff₁ of size 1×K to generate Diffp of size 1×2K, as shown in Equation 13. Hereinafter, Diffₚ is referred to as the concatenated bi-difference vector.

$${Diff}_{p} [ k ] = concat ( {Diff}_{1} [ k ] , {Diff}_{0} [ k ] ) \qquad [ Equation 13 ]$$

The video decoding device then normalizes each element of Diffₚ to calculate a weight vector Weight[k], as shown in Equation 14.

$$Weight [ k ] = \frac{\vert concat ( {Diff}_{1} , {Diff}_{0} ) [ k ] \vert}{{\sum }_{n = 0}^{2 K - 1} \vert concat ( {Diff}_{1} , {Diff}_{0} ) [ n ] \vert} \qquad [ Equation 14 ]$$

Here, concat denotes an operation that concatenates two vectors.

For a normalized weight vector Weight, Weight0 may be defined as the k=0 to K−1 elements in Weight[k], and Weight1 may be defined as the k=K to 2K−1 elements in Weight[k]. The video decoding device may then calculate the weights w0 and w1 of Equation 7 for the chroma component by calculating the sum of the vector elements of Weight0 and Weight1.

The video decoding device may perform a bi-prediction of the chroma component by using the calculated weights. For x=0, . . . , W−1, y=0, . . . , H−1, a final predicted sample Pred_{C}[x][y] of the chroma component may be calculated as shown in Equation 15.

$${Pred}_{C} [ x ] [ y ] = w 0 \times {pred}_{0 C} [ x ] [ y ] + w 1 \times {pred}_{1 C} [ x ] [ y ] \qquad [ Equation 15 ]$$

Here, pred0_{C} and pred1_{C} denote the forward prediction block and backward prediction block of the chroma block, respectively.

### <Implementation 2> Chroma BCW Using Template Matching

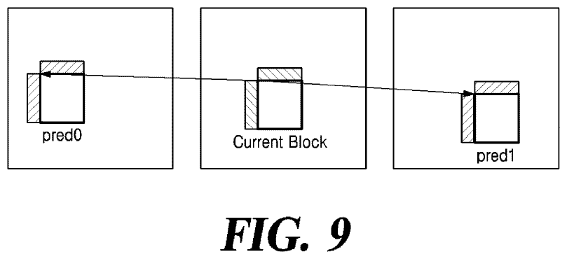

In this implementation, the video decoding device calculates the weights w0 and w1 of Equation 7 by using template matching. For example, the video decoding device may calculate the template matching cost by using the neighboring blocks of the prediction block in each predicted direction, as shown in the example of FIG. 9, and then normalize the calculated template matching cost to calculate the weights.

For example, to predict an N×N chroma block, the video decoding device may define (N+2)×2 samples at the top of the block and 2×N samples to the left of the block as templates. If the template matching cost is defined as the sum of squared differences (SSD), the video decoding device may calculate the template matching cost as shown in Equation 16.

$${\sum }_{i = 0}^{2 ( N + 2 ) - 1} {\sum }_{j = 0}^{2 N - 1} {( {T}_{curr} ( i , j ) - {T}_{ref} ( i , j ) )}^{2} \qquad [ Equation 16 ]$$

Here, T_{curr} and T_{ref} denote the template regions of the current block and the reference block. In addition to the SSD, the sum of absolute differences (SAD) based on |T_{curr}(i,j)−T_{ref} (i,j)| may be defined as the template matching cost.

The (N+2)×2 samples at the top of the block and the 2×N samples to the left are defined, but not necessarily, as the template and a previously reconstructed region neighboring the current block may also be defined as the template. For example, 2N samples at the top of the block and 2N samples to the left may be defined as the template.

Hereinafter, the template matching costs of pred0 and pred1 prediction blocks are defined as TC_{pred0} and TC_{pred1}, respectively. Hereinafter, TC_{pred0} and TC_{pred1} are referred to as the first template matching cost and the second template matching cost, respectively. After normalizing the two matching costs, the video decoding device may calculate the weights w0 and w1 as shown in Equation 17 to set a larger weight for the block with a smaller matching cost.

$$w 0 = \frac{{TC}_{pred 1}}{{TC}_{pred 0} + {TC}_{pred 1}} \qquad [ Equation 17 ]$$

$$w 1 = \frac{{TC}_{pred 0}}{{TC}_{pred 0} + {TC}_{pred 1}}$$

The video decoding device may then use the normalized w0 as the weight of pred0, and the normalized w1 as the weight of pred1.

In the foregoing examples, the neighboring samples of the chroma block are used to calculate the template matching cost, which does not limit the present disclosure. For example, instead of using the neighboring samples of the chroma block, the neighboring samples of the luma block may be used. In this case, instead of using a cost function as shown in Equation 10, the template matching cost may be calculated by using a cost function including a first-order linear function. The first-order linear function may be used to convert luma sample values to chroma sample values, as in the CCLM example described above.

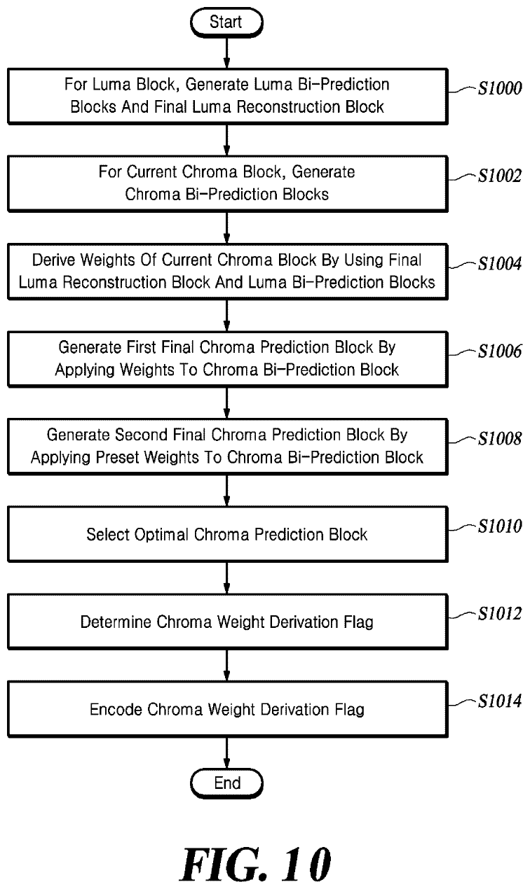

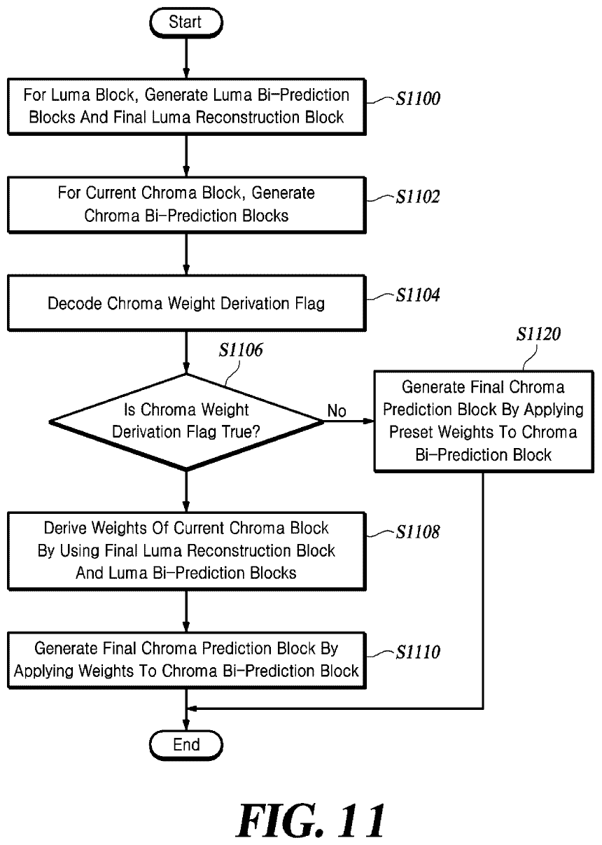

Referring now to FIGS. 10 and 11, a method used in a bidirectional inter prediction is described for deriving weights of a current chroma block and using the derived weights to generate a prediction block of the current chroma block.

FIG. 10 is a flowchart of a method of predicting a current chroma block performed by the video encoding device, according to at least one embodiment of the present disclosure.

The video encoding device generates, for the luma block, luma bi-prediction blocks and a final luma reconstruction block (S1000).

Here, the luma bi-prediction blocks include a first luma prediction block and a second luma prediction block. For example, the first luma prediction block may be a forward-prediction luma block and the second luma prediction block may be a backward-prediction luma block.

The video encoding device generates chroma bi-prediction blocks for the current chroma block corresponding to the luma block (S1002).

Here, the chroma bi-prediction blocks include a first chroma prediction block and a second chroma prediction block. For example, the first chroma prediction block may be a forward-prediction chroma block and the second chroma prediction block may be a backward-prediction chroma block.

The video encoding device derives weights of the current chroma block by using the final luma reconstruction block and the luma bi-prediction blocks (S1004). Here, the weights of the current chroma block include a first chroma weight w0 and a second chroma weight w1.

In one example, to derive the weights, the video encoding device may utilize the differences between the luma bi-prediction blocks and the final luma reconstruction block.

The video encoding device may calculate the absolute value of the difference between the final luma reconstruction block pred_{L}^{rec} and the first luma prediction block pred0_{L} to generate a first differential block Deltaₚ₀. The video encoding device may also calculate the absolute value of the difference between the final luma reconstruction block and the second luma prediction block pred1_{L} to generate a second differential block Deltaₚ₁.

At this time, if the luma block is larger than the current chroma block, the video encoding device may generate the first differential block and the second differential block after downsampling the luma bi-prediction blocks and the final luma reconstruction block. Alternatively, the video encoding device may generate the first differential block and the second differential block first, and then downsample the first differential block and the second differential block.

The video encoding device normalizes the first differential block and the second differential block based on the sum of the first differential block and the second differential block to generate a first weighted block w0[x][y] and a second weighted block w1 [x][y].

As described above, per-pixel weights may be utilized, but one weight per prediction block may also be utilized. The video encoding device calculates a first mean, which is an average of the elements of the first differential block, and a second mean, which is an average of the elements of the second differential block. The video encoding device may then normalize the first mean and the second mean to generate a first chroma weight w0 and a second chroma weight w1.

As another example, the video encoding device may utilize the differences between the luma blocks and the neighboring luma samples.

The video encoding device may generate a first difference vector Deltaₚ₀ by calculating the absolute values of the differences between the pixels in the first luma prediction block and the neighboring pixels Ref₀ of the first luma prediction block. The video encoding device generates the luma difference vector Delta_{L} by calculating the absolute values of the differences between the pixel in the final luma reconstruction block and the neighboring pixels Ref_{L} of the final luma reconstruction block. The video encoding device also generates the second difference vector Deltaₚ₁ by calculating the absolute values of the differences between the pixel in the second luma prediction block and the neighboring pixels Ref₁ of the second luma prediction block.

The video encoding device generates a first bi-difference vector Diff₀ by calculating the absolute value of the difference between the first difference vector and the luma difference vector. The video encoding device also generates a second bi-difference vector Diff₁ by calculating the absolute value of the difference between the second difference vector and the luma difference vector.

The video encoding device concatenates the first bi-difference vector and the second bi-difference vector to generate a concatenated bi-difference vector Diffₚ. The video encoding device may normalize the respective elements of the concatenated bi-difference vector, and may use the normalized elements to generate the first chroma weight w0 and the second chroma weight w1.

As another example, to derive the weights, the video encoding device may calculate a first template matching cost TC_{pred0} and a second template matching cost TC_{pred0} by using the neighboring blocks of the prediction block in each predicted direction. After normalizing the calculated template matching costs, the video encoding device may calculate a first chroma weight w0 and a second chroma weight w1 according to Equation 17 to set a larger weight for a block with smaller matching cost.

The video encoding device applies the weights to the chroma bi-prediction block to generate the first final chroma prediction block of the current chroma block (S1006).

When per-pixel weights are utilized, the video encoding device may apply the first weighted block and the second weighted block on a per-pixel basis to the first chroma prediction block pred0_{C} and the second chroma prediction block pred0_{C} to generate the first final chroma prediction block, as shown in Equation 10.

In the case of using the weight per prediction block, the video encoding device may apply the first chroma weight and the second chroma weight to the first chroma prediction block and the second chroma prediction block to generate the first final chroma prediction block, as shown in Equation 11.

The video encoding device applies the preset weights to the chroma bi-prediction blocks to generate a second final chroma prediction block of the current chroma block (S1008). For example, the video encoding device may generate the second final chroma prediction block of the current chroma block by using the preset weights according to the BCW.

The video encoding device selects an optimal chroma prediction block between the first final chroma prediction block and the second final chroma prediction block (S1010). For example, the video encoding device may select the optimal chroma prediction block in terms of optimizing distortion from the original chroma block.

As described above, a flag indicating whether chroma weights are to be derived or not is referred to as a chroma weight derivation flag.

The video encoding device determines the chroma weight derivation flag based on whether the optimal chroma prediction block is the first final chroma prediction block or the second final chroma prediction block (S1012).

The video encoding device encodes the chroma weight derivation flag (S1014).

FIG. 11 is a flowchart of a method of predicting a current chroma block performed by the video decoding device, according to at least one embodiment of the present disclosure.

The video decoding device generates, for the luma block, luma bi-prediction blocks and a final luma reconstruction block (S1100).

Here, the luma bi-prediction blocks include a first luma prediction block and a second luma prediction block. For example, the first luma prediction block may be a forward-prediction luma block and the second luma prediction block may be a backward-prediction luma block.

The video decoding device generates chroma bi-prediction blocks for the current chroma block corresponding to the luma block (S1102).

Here, the chroma bi-prediction blocks include a first chroma prediction block and a second chroma prediction block. For example, the first chroma prediction block may be a forward-prediction chroma block and the second chroma prediction block may be a backward-prediction chroma block.

The video decoding device decodes the chroma weight derivation flag (S1104).

The video decoding device checks the chroma weight derivation flag (S1106).

If the chroma weight derivation flag is true (Yes in S1106), the video decoding device performs the following steps (S1108 and S1110).

The video decoding device derives the weights of the current chroma block by using the final luma reconstruction block and the luma bi-prediction blocks (S1108). Here, the weights of the current chroma block include a first chroma weight and a second chroma weight.

The method performed by the video decoding device for deriving the weights are not be described further because the video decoding device may take the same method as with the video encoding device.

The video decoding device applies the weights to the chroma bi-prediction block to generate a final chroma prediction block of the current chroma block (S1110).

On the other hand, if the chroma weight derivation flag is false (No in S1106), the video decoding device applies the preset weights to the chroma bi-prediction blocks to generate a final chroma prediction block (S1120). For example, the video decoding device may generate the final chroma prediction block of the current chroma block by using the preset weights according to the BCW.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
155: entropy encoder
510: entropy decoder
544: inter predictor

### CROSS-REFERENCE TO RELATED APPLICATIONS

This application claims priority to and the benefit of Korean Patent Application No. 10-2022-0058181 filed on May 12, 2022, and Korean Patent Application No. 10-2023-0048426, filed on Apr. 12, 2023, the entire contents of each of which are incorporated herein by reference.

What is claimed is:

1. A method performed by a video decoding device for predicting a current chroma block, the method comprising:
generating, for the current chroma block, chroma bi-prediction blocks that include a first chroma prediction block and a second chroma prediction block;
deriving weights of the current chroma block by using a first luma prediction block, a second luma prediction block, and a final luma reconstruction block of a luma block corresponding to the current chroma block, the weights including a first chroma weight and a second chroma weight; and
generating a final chroma prediction block of the current chroma block by applying the weights to the chroma bi-prediction blocks.

2. The method of claim 1, further comprising:
decoding a flag indicating whether the weights of the current chroma block are to be derived; and
checking the flag,
wherein, when a value of the flag is true, the method further comprises,
deriving the weights.

3. The method of claim 1, further comprising:
generating, for the luma block, the first luma prediction block, the second luma prediction block, and the final luma reconstruction block.

4. The method of claim 1, wherein deriving the weights comprises:
generating a first differential block by calculating an absolute value of a difference between the final luma reconstruction block and the first luma prediction block; and
generating a second differential block by calculating an absolute value of a difference between the final luma reconstruction block and the second luma prediction block.

5. The method of claim 4, wherein deriving the weights comprises:
generating a first weighted block and a second weighted block by normalizing the first differential block and the second differential block based on a sum of the first differential block and the second differential block.

6. The method of claim 5, wherein generating the final chroma prediction block comprises:
applying the first weighted block and the second weighted block on a pixel-by-pixel basis to the first chroma prediction block and the second chroma prediction block.

7. The method of claim 4, further comprising:
when the luma block is larger than the current chroma block, downsampling the first luma prediction block, the second luma prediction block, and the final luma reconstruction block before generating the first differential block and the generating of the second differential block.

8. The method of claim 4, wherein deriving the weights comprises:
generating the first chroma weight and the second chroma weight by calculating a first mean that is an average of elements of the first differential block and a second mean that is an average of elements of the second differential block and by normalizing the first mean and the second mean.

9. The method of claim 1, wherein deriving the weights comprises:
generating a first difference vector by calculating absolute values of differences between a pixel in the first luma prediction block and neighboring pixels of the first luma prediction block;
generating a luma difference vector by calculating absolute values of differences between a pixel in the final luma reconstruction block and neighboring pixels of the final luma reconstruction block; and
generating a second difference vector by calculating absolute values of differences between a pixel in the second luma prediction block and neighboring pixels of the second luma prediction block.

10. The method of claim 9, wherein deriving the weights further comprises:
generating a first bi-difference vector by calculating an absolute value of a difference between the first difference vector and the luma difference vector; and
generating a second bi-difference vector by calculating an absolute value of a difference between the second difference vector and the luma difference vector.

11. The method of claim 10, wherein deriving the weights further comprises:
generating a concatenated bi-difference vector by concatenating the first bi-difference vector and the second bi-difference vector; and
generating the first chroma weight and the second chroma weight by normalizing respective elements of the concatenated bi-difference vector into normalized elements and by using the normalized elements.

12. A method performed by a video encoding device for predicting a current chroma block, the method comprising:
generating, for the current chroma block, chroma bi-prediction blocks that include a first chroma prediction block and a second chroma prediction block;
deriving weights of the current chroma block by using a first luma prediction block, a second luma prediction block, and a final luma reconstruction block of a luma block corresponding to the current chroma block, the weights including a first chroma weight and a second chroma weight; and
generating a first final chroma prediction block of the current chroma block by applying the weights to the chroma bi-prediction blocks.

13. The method of claim 12, further comprising:
generating a second final chroma prediction block of the current chroma block by applying preset weights to the chroma bi-prediction blocks; and
selecting an optimal chroma prediction block between the first final chroma prediction block and the second final chroma prediction block.

14. The method of claim 13, further comprising:
determining a flag indicating whether the weights are to be derived based on whether the optimal chroma prediction block is the first final chroma prediction block or the second final chroma prediction block; and
encoding the flag.

15. The method of claim 12, further comprising:
generating, for the luma block, the first luma prediction block, the second luma prediction block, and the final luma reconstruction block.

16. A computer-readable recording medium storing a bitstream generated by a video encoding method, the video encoding method comprising:
generating, for a current chroma block, chroma bi-prediction blocks that include a first chroma prediction block and a second chroma prediction block;
deriving weights of the current chroma block by using a first luma prediction block, a second luma prediction block, and a final luma reconstruction block of a luma block corresponding to the current chroma block, the weights including a first chroma weight and a second chroma weight; and
generating a final chroma prediction block of the current chroma block by applying the weights to the chroma bi-prediction blocks.
